(19) United States
(12) Patent Application Publication
(10) Pub. No.: US 2026/0235191 A1
(43) Pub. Date: Aug. 13, 2026

(54) TIMING CHAIN TENSIONER GUIDE

(71) Applicant: KATECH ENGINEERING, LLC, Clinton Township, MI (US)

(72) Inventors: Eric Suits, Clinton Township, MI (US); Wheeler Stow, Clinton Township, MI (US); Devon Freeland, Clinton Township, MI (US); Rhyan Lang, Clinton Township, MI (US)

(73) Assignee: KATECH ENGINEERING, LLC, Clinton Township, MI (US)

(21) Appl. No.: 19/630,915

(22) Filed: Mar. 27, 2026

Related U.S. Application Data
(60) Provisional application No. 63/755,385, filed on Feb. 7, 2025.

(51) Int. Cl. F16H 7/18; F16H 7/08

(52) U.S. Cl. CPC F16H 7/18; F16H 2007/0893; F16H 2007/0897; F16H 2007/185

(57) ABSTRACT

A one-piece timing chain tensioner guide is provided that includes a rear face and an opposite front face spaced apart from the rear face by a width. The guide has a curved outer surface, and an opposite curved inner surface separated from the curved outer surface by a thickness, the curved outer surface and the curved inner surface extending along a length of the tensioner guide from a first end of the guide to a second end of the guide. A first through hole positioned near the first end of the tensioner guide and extending from the rear face to the front face is also present. The timing chain tensioner guide provides superior performance and durability, particularly under increased loading and fatigue compared to conventional guides.

### RELATED APPLICATIONS

This application is a non-provisional application that claims priority benefit of U.S. Provisional Application Ser. No. 63/755,385, filed 7 Feb. 2025; the contents of which are hereby incorporated by reference.

### FIELD OF THE INVENTION

The present invention relates to the automotive chain drive art, and more particularly to chain tensioner guide apparatus that is designed for superior performance and durability and less failure, particularly under increased loading and fatigue for applying a tensioning force to a chain traveling there past.

### BACKGROUND OF THE INVENTION

Several prior patents describe various chain tensioner devices that include a chain engaging blade or shoe member, typically molded from a resinous plastic material, having a metal spring installed therein to provide the shoe sub-assembly with the necessary rigidity and damping characteristics while taking advantage of the flexibility, low friction, and good wear properties of the plastic shoe.

For example, FIG. 1 from U.S. Pat. No. 8,715,122 shows an exemplary known tensioner apparatus T′ comprising a bracket K typically defined from a metal stamping and a tensioner blade assembly BAS′ operably secured to the bracket K. The bracket K is fixedly secured to an associated engine block EB (FIG. 2 from U.S. Pat. No. 8,715,122) as part of a chain drive system that is provided to phase or “time” the rotational position of one or more camshaft sprockets CMS with respect to the rotational position of the crankshaft sprocket CKS. A chain 15 such as a roller/bush chain or inverted tooth chain is engaged with the crankshaft sprocket CKS and the camshaft sprocket(s) CMS and phases/times the camshaft sprocket(s) to the crankshaft sprocket. The crankshaft sprocket CKS rotates in a direction DIR, and the chain 15 includes a taut strand portion 16 and a slack strand portion 17.

In the illustrated embodiment, the known tensioner T′ comprises an optional fixed chain guide portion FG. The fixed chain guide portion comprises a fixed guide flange XF that projects transversely from the main wall MW of the bracket K and that is engaged with and supports a fixed chain guide G defined from a polymeric (plastic) material. The fixed chain guide G includes a guide face GF that slidably engages and supports the taut strand 16 of the chain as shown in FIG. 2.

The tensioner T′ further comprises a tensioner portion TP. To define the tensioner portion TP, the bracket K comprises a pin P that is welded or otherwise securely affixed to the main wall MW and that projects perpendicularly outward there from. The bracket K further comprises a support flange TF that projects outwardly from the main wall MW. An end of the support flange TF forms or defines a ramp R, and an outer wall OW extends transversely from an outer end of the ramp R and extends parallel to the main wall MW such that a channel CH is defined between the main wall MW, the outer wall OW, and the ramp R.

A known tensioner blade assembly BAS′ includes a polymeric or “plastic” shoe B′ and a metal spring S releasably connected to the shoe B′. A first or pivot end B1′ of the blade assembly BAS′ includes a boss or barrel BL that includes pivot bore PB that is slidably received onto the pivot pin P. An opposite second or free end B2′ of the blade assembly BAS′ is located in the channel CH supported on the ramp R. The bracket K thus maintains the blade assembly BAS′ in its proper position with respect to the plane of the chain path while permitting sliding reciprocal translational motion of the second, free end B2′ on the ramp R as indicated by the arrow “TRANS” along with the related rotational movement of the blade assembly BAS′ at the pivot end B1′ as indicated by the arrow labeled “ROTATE” in response to changes in the tension and position of the slack strand 17 of the chain 15 and corresponding oscillatory movement of the slack strand 17 as indicated by the arrow “AMPL.”

FIG. 3 shows the known blade assembly BAS′ by itself, separated from the bracket K. The shoe B′ is a one-piece molded polymeric construction and the spring S is a one-piece metal stamping leaf-spring structure or the like. The shoe B′ includes a rear face RF that lies adjacent and/or slidably abuts the main wall of the bracket K when the blade assembly BAS′ is operatively installed on the bracket K. The shoe B′ also includes an opposite front face FF that is spaced from the bracket main wall MW and that faces away from the bracket main wall MW when the blade assembly BAS′ is operatively installed on the bracket T.

The pivot end B1′ of the shoe B′ and a free end B2′ of the shoe B′ define respective first and second spring-receiving slots L1′, L2′ for receiving and retaining opposite ends S1,S2 of the spring S. The shoe B′ includes a thin and flexible central body B3 that extends between and interconnects the pivot and free ends B1′, B2′. An upper or outer surface OS of the central body B3 provides a smooth chain contact surface for being slidably engaged by an associated chain being tensioned. The central body B3 includes a lower or inner surface IS that is defined by the underside of the central body B3 that is opposite the outer surface OS. The inner surface IS is contacted by an arched central portion S3 of the spring S.

The first end S1 of the spring S is retained in the slot L1′ between a first outer wall W1 and the main wall MW of the bracket K. The first outer wall W1 abuts or lies closely adjacent an outer spring edge E1 and an inner spring edge E2 lies closely adjacent and/or in contact with the main wall MW of the bracket K. The second end S2 of the spring S is retained in the slot L2′ between a second outer wall W2 and the bracket main wall MW. The second outer wall W2 abuts or lies closely adjacent the outer spring edge E1 and the inner spring edge E2 abuts and/or lies closely adjacent the bracket main wall MW. The spring S exerts a biasing force on the flexible central body B3 of the shoe B′ so that the guide face GF is urged into contact with the slack strand 17 to apply the necessary tensioning force to the slack strand 17and so that the shoe B′ and spring S absorb or eliminate all looseness in the slack strand 17.

Such tensioner blade assemblies BAS′ have enjoyed widespread commercial success, being used in many commercially available vehicles, particularly General Motors™ “LT” Based engines, described as V8 internal combustion engines since 2013. However, such tensioner blade assemblies BAS′ experience failures under increased loading and fatigue due in part to is the brittle fracture of the polymeric shoe B′, due to insufficient material thickness given the loading experienced by the component in its commercial embodiment. Furthermore, repetitive high-speed sliding contact between the inner spring edge E2 and the bracket main wall MW of the bracket K during use of the tensioner T′ causes polishing of the main wall MW—and in cases where the chain drive dynamics are excessive—erosion of the main wall is known to occur, particularly near the spring ends, and this may induce relative movement of the spring S relative to the plastic shoe B′ due to friction between the spring inner edge E2 and the bracket main wall MW, which leads to abrading or cutting damage of the plastic shoe B′ in the areas where it is contacted by the spring S.

Thus, there exists a need for a timing chain tensioner guide that is designed for superior performance and durability and less failure, particularly under increased loading and fatigue. There is an additional need for such a superior timing chain tensioner guide to install seamlessly into an existing OEM tensioner housing, ensuring an effortless fit and compatibility with an existing vehicle setup.

### SUMMARY OF THE INVENTION

A one-piece timing chain tensioner guide is provided that includes a rear face and an opposite front face spaced apart from the rear face by a width. The guide has a curved outer surface, and an opposite curved inner surface separated from the curved outer surface by a thickness, the curved outer surface and the curved inner surface extending along a length of the tensioner guide from a first end of the guide to a second end of the guide. A first through hole positioned near the first end of the tensioner guide and extending from the rear face to the front face is also present. The timing chain tensioner guide provides superior performance and durability, particularly under increased loading and fatigue compared to conventional guides.

### BRIEF DESCRIPTION OF THE DRAWINGS

The present invention is further detailed with respect to the following figures that depict various aspects of the present invention.

FIG. 1 shows a known tensioner apparatus comprising a bracket and a tensioner blade assembly operably secured to the bracket;

FIG. 2 shows the known tensioner apparatus of FIG. 1 operatively installed on an engine to tension and guide a chain of an associated chain drive system;

FIG. 3 is an exploded isometric view of the known blade assembly of FIGS. 1-2;

FIG. 4A shows a front view of a tensioner guide according to embodiments of the present invention;

FIG. 4B shows a rear perspective view of a tensioner guide according to embodiments of the present invention;

FIG. 5 shows a front view of a tensioner guide according to embodiments of the present invention;

FIG. 6 shows a front view of a tensioner guide according to embodiments of the present invention installed on an existing tensioner bracket;

FIG. 7 shows a tensioner guide according to embodiments of the present invention installed on the existing bracket shown in FIG. 6 and operatively installed on an engine to tension and guide a chain of an associated chain drive system; and

FIG. 8 shows dimensions of a tensioner guide according to embodiments of the present invention.

### DESCRIPTION OF THE INVENTION

The present invention has utility as a timing chain tensioner guide that is designed for superior performance and durability and less failure, particularly under increased loading and fatigue. The inventive timing chain tensioner guide installs seamlessly into an existing OEM tensioner housing, ensuring an effortless fit and compatibility with an existing vehicle timing chain tensioner setup.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

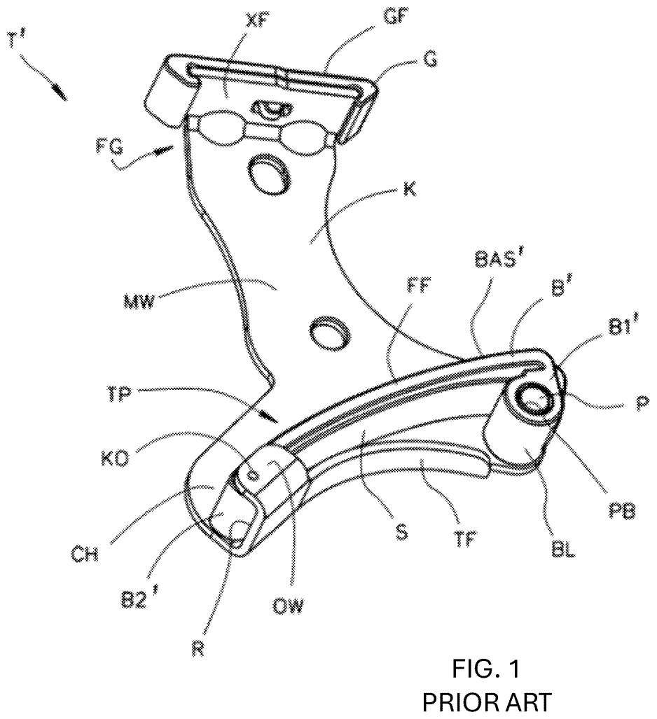

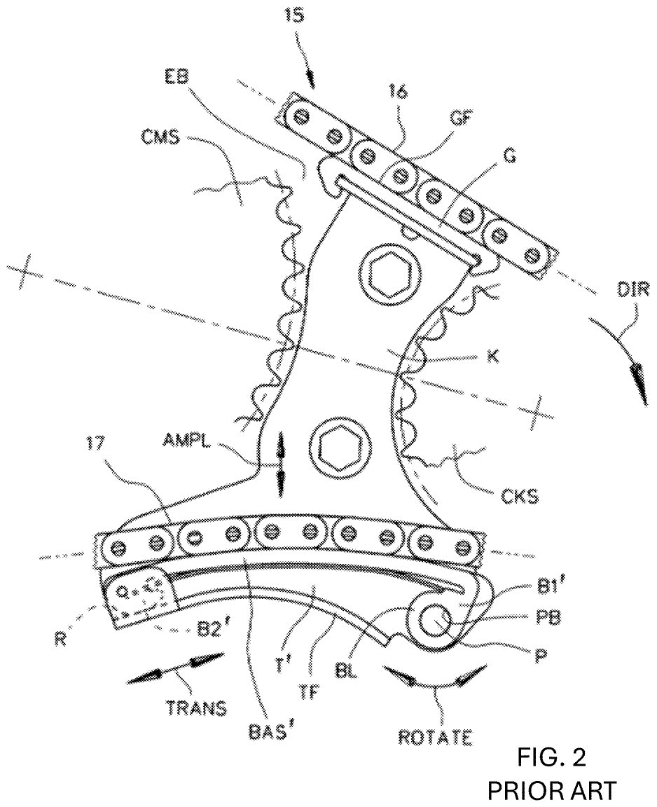

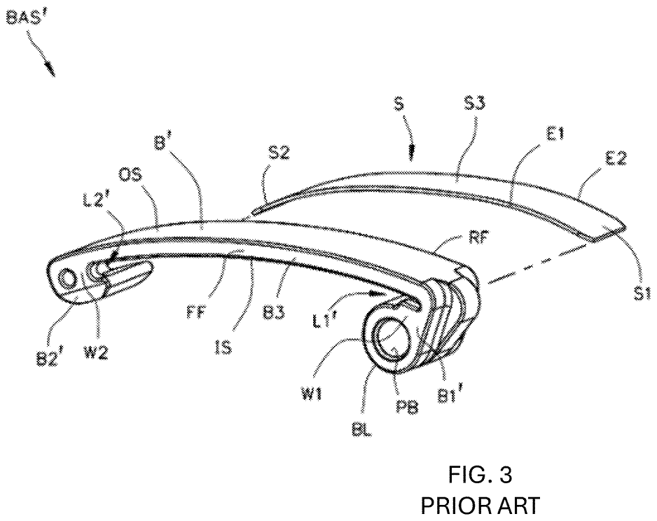

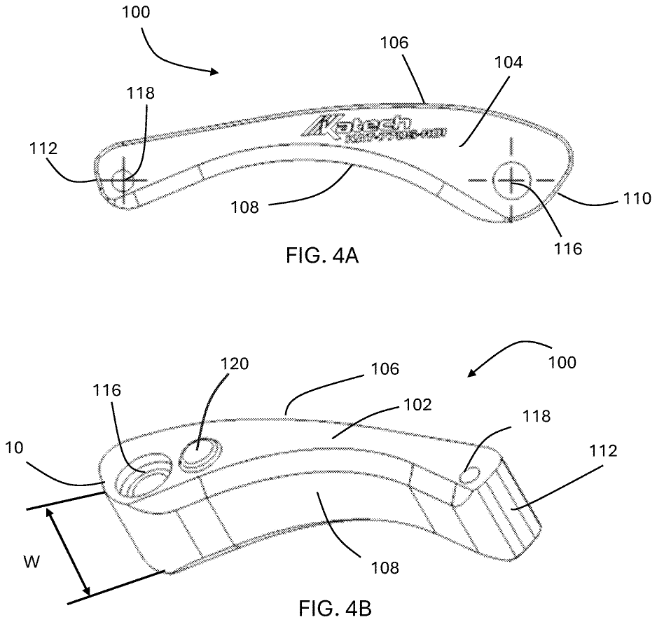

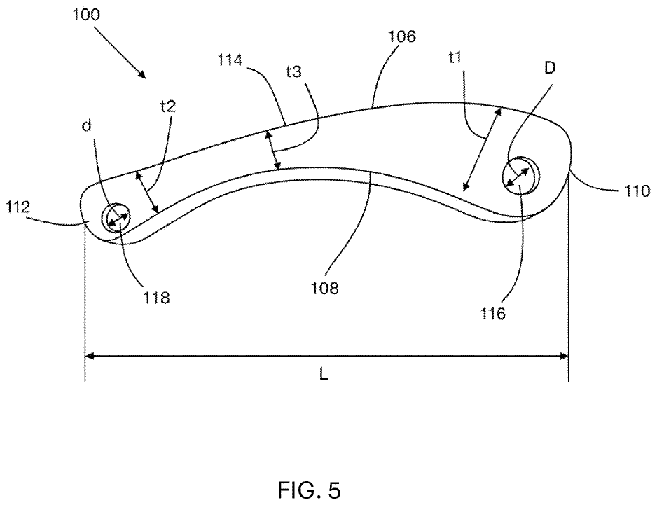

According to embodiments, the inventive timing chain tensioner guide 100 is a replacement for the two part blade assembly BAS′, such as that shown in FIGS. 1-3 and therefore seamlessly installs into an existing on the bracket K of an OEM tensioner housing, such as that shown in FIGS. 1, 2, and 6. The inventive timing chain tensioner guide 100 thus replaces the shoe B′ and the spring S that make up the blade assembly BAS′, which are prone to failure.

As shown in FIGA. 4A, 4B, and 5, embodiments of the inventive timing chain tensioner guide 100 include a one-piece polymeric body. The body of the tensioner guide 100 includes a rear face 102 and an opposite front face 104 that is spaced from the rear face 102 by a width W. The tensioner guide 100 additionally includes an upper or outer surface 106 and an opposite lower or inner surface 108 that are separated from each other by a thickness t. The outer surface 106 and the inner surface 108 both extend from a first end 110 to a second end 112 of the guide 100. The first end 110 is separated from the second end 112 by a length L. The outer surface 106 and the inner surface 108 are both curved. The outer surface 106 is a convex curve in that it curves outward away from the guide 100, whereas the inner surface 108 is a concave curve in that it curves inward toward the guide 100. Furthermore, the thickness t between the outer surface 106 and the inner surface 108 tapers from a larger first thickness t1 near the first end 110 to a smaller second thickness t2 near the second end 112. According to some embodiments, the thickness t between the outer surface 106 and the inner surface 108 is a smallest third thickness t3 at a central portion 114 of the guide 100.

Near the first end 110 the guide 100 defines a first through hole 116 therein having a first diameter D. The first through hole 116 extends from the rear face 102 to the front face 104. The first through hole 116 is configured to receive the pivot pin P of the bracket K. According to embodiments, a second through hole 118 having a second diameter d that is smaller than the first diameter D is defined in the guide 100 near the second end 112. The second through hole 118 extends from the rear face 102 to the front ace 104. The guide additionally includes a bump 120 that extends from the rear face 102 of the guide. The bump 120 is positioned near the first through hole 116. The bump 120 is configured to contact the main wall MW of the bracket K.

According to embodiments, the timing guide 100 is formed of a one-piece, unitary polymeric body. According to embodiments, the polymeric material is an advanced wear-resistant and temperature resistant material that delivers exceptional longevity and reliability under demanding conditions and withstands extreme operating conditions. According to embodiments, the polymeric material is at least one of polyetheretherketone, polyamide-imide, polyphenylene sulfide, polyimide, polyphenylene oxide, DELRIN®, UHMW-PE, polyphenylenesulfone, polyethersulfone, polycarbonate and methacrylate butadiene styrene copolymer.

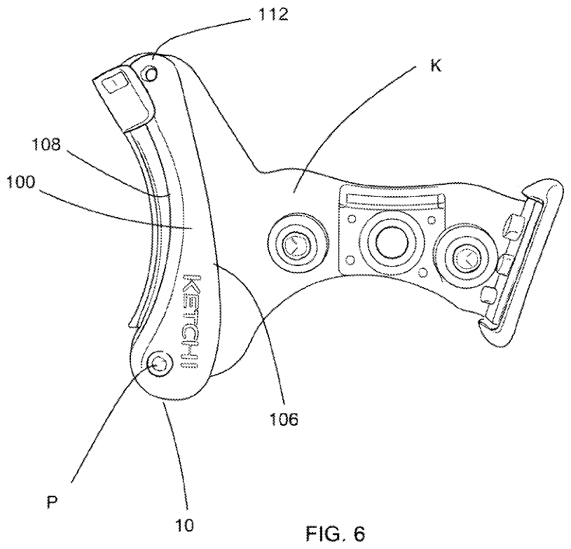

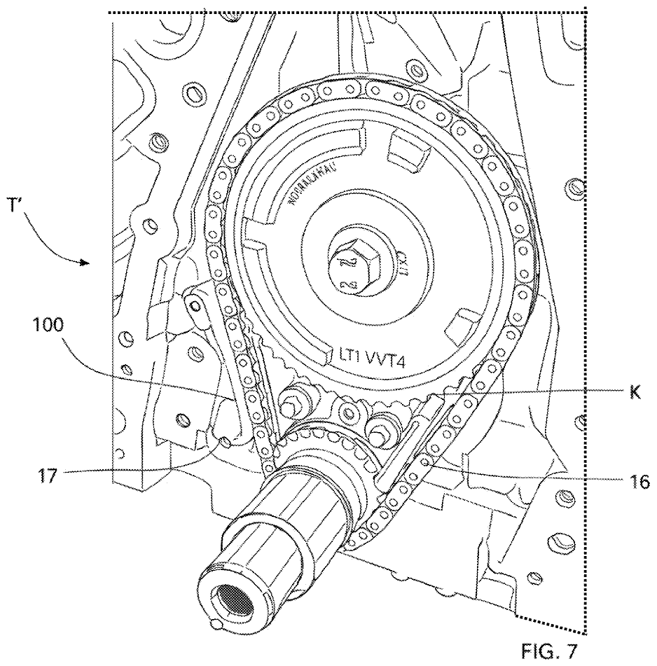

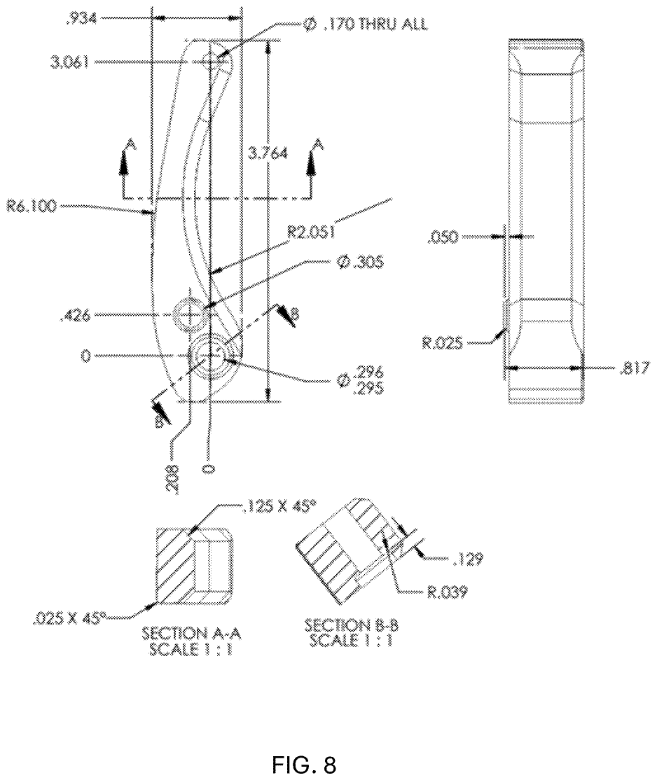

In use, the inventive timing guide 100 is installed on the bracket K of an existing tensioner T′, such as that shown in FIG. 6. The rear face 102 of the guide 100 is configured to lie adjacent to the main wall of the bracket K with the bump 120 on the rear face 102 being in slidable engagement with the main wall of the bracket K when the tensioner guide 100 is operatively installed on the bracket K. The first through hole 116 in the first end 110 is configured to receive the pivot pin P of the bracket K. The opposite second end 112 is configured to be located in the channel CH supported on the ramp R of the bracket K. The outer surface 106 of the guide 100 provides a chain contact surface for being slidably engaged by an associated chain being tensioned. The bracket K thus maintains the guide 100 in its proper position with respect to the plane of the chain path while permitting sliding reciprocal translational motion of the second end 112 on the ramp R along with the related rotational movement of the guide 100 at the first end 110 as it pivots about the pivot in P in response to changes in the tension and position of the slack strand 17 of the chain 15 and corresponding oscillatory movement of the slack strand 17. Notably, the inventive timing guide 100 does not include a separate spring to urge the outer surface 106 into contact with the chain or belt. Instead, the inventive timing guide 100 relies on the centripetal acceleration of the typical chain assembly to force a belt, rope, or chain into the outer surface 106 of the inventive guide 100.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A one-piece timing chain tensioner guide comprising:
a rear face and an opposite front face spaced apart from the rear face by a width;
a curved outer surface and an opposite curved inner surface separated from the curved outer surface by a thickness, the curved outer surface and the curved inner surface extending along a length of the tensioner guide from a first end of the guide to a second end of the guide;
a first through hole positioned near the first end of the tensioner guide and extending from the rear face to the front face, the first through hole having a first diameter.

2. The one-piece timing chain tensioner guide of claim 1 wherein the curved outer surface features a convex curve.

3. The one-piece timing chain tensioner guide of claim 1 wherein the curved inner surface features a concave curve.

4. The one-piece timing chain tensioner guide of claim 1 wherein the curved outer surface is smooth.

5. The one-piece timing chain tensioner guide of claim 1 wherein the curved outer surface is configured to slidably engage a chain being tensioned by a tensioner.

6. The one-piece timing chain tensioner guide of claim 1 wherein the first through hole is configured to receive a pivot pin of an existing OEM tensioner bracket.

7. The one-piece timing chain tensioner guide of claim 1 wherein the thickness between the curved outer surface and the curved inner surface is tapered along the length of the tensioner guide.

8. The one-piece timing chain tensioner guide of claim 1 wherein the tensioner guide has a first thickness near the first end thereof and a second thickness at the second end thereof, the first thickness being greater than the second thickness.

9. The one-piece timing chain tensioner guide of claim 8 wherein the tensioner guide has a third thickness at a central portion thereof, the third thickness being less that the first thickness and the second thickness.

10. The one-piece timing chain tensioner guide of claim 1 wherein the tensioner guide is a unitary body formed of a polymeric material.

11. The one-piece timing chain tensioner guide of claim 10 wherein the polymeric material is wear resistant.

12. The one-piece timing chain tensioner guide of claim 10 wherein the polymeric material is heat resistant.

13. The one-piece timing chain tensioner guide of claim 1 wherein the tensioner guide does not include a spring.

14. The one-piece timing chain tensioner guide of claim 1 further comprising a second through hole positioned near the second end of the tensioner guide and extending from the rear face to the front face, the second through hole having a second diameter.

15. The one-piece timing chain tensioner guide of claim 14 wherein the second diameter is less than the first diameter.

16. The one-piece timing chain tensioner guide of claim 1 further comprising a bump extending from the rear face of the tensioner guide.

17. The one-piece timing chain tensioner guide of claim 16 wherein the bump is positioned near the first through hole.

18. The one-piece timing chain tensioner guide of claim 16 wherein the bump is a circle.
